(19) United States
(12) Patent Application Publication
(10) Pub. No.: US 2018/0062297 A1
(43) Pub. Date: Mar. 1, 2018

(54) PIN TERMINAL AND CONNECTOR

(71) Applicant: Yazaki Corporation, Tokyo (JP)

(72) Inventors: Toshifumi Suzuki, Shizuoka (JP); Masakazu Nagaoka, Shizuoka (JP); Toshimasa Yoshigi, Shizuoka (JP)

(21) Appl. No.: 15/665,038

(22) Filed: Jul. 31, 2017

(30) Foreign Application Priority Data
Aug. 29, 2016 (JP) 2016-166446

(51) Int. Cl. H01R 13/422

(52) U.S. Cl. CPC H01R 13/422

(57) ABSTRACT

A pin terminal has a terminal body, a biting portion, and a blocking member. The terminal body is cut from a pre-plated metal wire rod, and passes through a terminal insertion hole in a state that a space is provided between inner wall surfaces of the terminal insertion hole in the first direction intersecting with a pressing direction when pressed into the terminal insertion hole. The biting portion projects from a middle of the terminal body in a second direction intersecting with both the pressing direction and the first direction, and bites into the inner wall surface when pressed into. The blocking member formed behind the biting portion in the pressing direction with a width wider than a width of the terminal body, and blocks at least a part of the space in the pressure inlet of the terminal insertion hole when pressed into.

The present invention relates to a pin terminal pressed into a terminal insertion hole in a connector housing and a connector including the pin terminal.

### BACKGROUND OF THE INVENTION

Conventionally, as a pin terminal used in a connector, a pin terminal which is pressed into a terminal insertion hole of a connector housing is well-known (for example, see Patent Literature 1 or 2) to be capable of relatively inexpensively attaching it compared with insert-molding which tends to increase costs in facility.

The pin terminal disclosed in the Patent Literature 1 is used for a board connector, and the pin terminal disclosed in the Patent Literature 2 is used for a relay connector so as to be electrical connected inside and outside a transmission. In an example of the Patent Literature 2, high sealing performance is required for the relay connector in order to prevent oil leaks from the transmission, and after the pin terminal is pressed, a sealing member is filled into a connector housing so as to block a terminal insertion hole.

Patent Literature 1: JP 2011-198594 A

Patent Literature 2: JP 2000-133371 A

### SUMMARY OF THE INVENTION

Meanwhile, in order to suppress press-fitting resistance of the metallic pin terminal to a terminal insertion hole in a resin connector housing and reduce generation of resin shavings caused when pressed into the terminal insertion hole, the terminal insertion hole is formed such that a space is opened between parts of outer periphery surfaces of the pin terminal. In this case, as an example of the patent Literature 2, when the sealing member is filled in the connector housing, the sealing member before curing may be leaked from the above space. The leaked seal material like this adheres to a connection point with a mating side terminal in the pin terminal, and thereby is likely to bring degradation of electrical connecting performance. Further, reduction of sealing performance in the terminal insertion hole may be caused due to the leakage of sealing material.

Therefore, in view of the foregoing problem, the present invention aims to provide a pin terminal which can suppress leakage of the sealing member from the terminal insertion hole when the sealing member is filled in the connector housing, and a connector having the pin terminal.

In order to solve the above issue, a pin terminal of the present invention is a pin terminal pressed into a terminal insertion hole from a pressure inlet in a connector housing. The pin terminal has a terminal body cut from a pre-plated metal wire rod, and passing through the terminal insertion hole in a state that a space is provided between inner wall surfaces of the terminal insertion hole in a first direction intersecting with a pressing direction when pressed into the terminal insertion hole; a biting portion projecting from a middle of the terminal body in a second direction intersecting with both the pressing direction and the first direction, and biting into the inner wall surface when pressed into the terminal insertion hole; and a blocking member formed behind the biting portion in the terminal body in the pressing direction with a width wider than a width of the terminal body in the first direction, and blocking at least a part of the space in the pressure inlet when pressed into the terminal insertion hole.

The pin terminal of the present invention is satisfactory pressed and held in the terminal insertion hole since the biting portion bites into the inner wall surface of terminal insertion hole. At this time, generation of shavings when pressed into the terminal insertion hole can be reduced due to the space between the inner wall surface of the terminal insertion hole and the terminal body in the first direction. Furthermore, according to the pin terminal of the present invention, at least a part of the space in the pressure inlet of the terminal insertion hole is blocked by the blocking member when pressed into the terminal insertion hole. Thereby, the leakage of the sealing member from the terminal insertion hole when the sealing member is filled in the connector housing can be suppressed.

Herein, in the pin terminal of the present invention, it is preferable that the pressure inlet has a tapered shape in which a gap in the first direction narrows in the pressing direction. Furthermore, it is preferable that a front side of the blocking member in the pressing direction has a tapered shape fitted into the tapered shape of the pressure inlet.

According to the preferred pin terminal, the pressure inlet of the terminal insertion hole is blocked by the blocking member across the depth of the tapered shape. Therefore, the leakage of the sealing member can be further suppressed. Further, according to the preferred pin terminal, since the blocking member has the tapered shape fitted into the tapered shape of the pressure inlet of the terminal insertion hole, a slope of the pin terminal can be prevented in the terminal insertion hole, and the positioning thereof can be performed with high accuracy.

Further, in the pin terminal of the present invention, it is preferable that the terminal insertion hole is a square hole, the terminal body has a square shape cut from a square wire rod as the metal wire rod, and passes through the terminal insertion hole in a state that the space is provided between first opposing surfaces among the inner wall surfaces in the first direction as a width direction perpendicular to a first pair of parallel surfaces among four peripheral surfaces of the terminal body, and the first opposing surfaces being faced to the first pair of parallel surfaces respectively, the biting portion projects in the second direction as a width direction perpendicular to a second pair of parallel surfaces other than the first pair of parallel surfaces among the four peripheral surfaces, and bites into second opposing surfaces among the inner wall surfaces, the second opposing surfaces being faced to the second pair of parallel surfaces respectively, and the blocking member is formed wider in the first direction.

According to the preferred pin terminal, the terminal insertion hole and the terminal body correspond to each other in shapes. Further, the biting portions bite into the opposing surfaces respectively faced to the other of the pair of parallel surfaces. Therefore, the biting portion bites into the opposing surface approximately vertically, and holding strength of the pin terminal when pressed. Furthermore, since the blocking member is formed to be wide in the first direction along the opposing direction, the blocking member blocks the space between the flat surfaces faced to each other. Thus, for example, in comparison with a case that a space between curved surfaces is blocked, the space can be blocked across a wide range, and the leakage of the sealing member can be further suppressed.

Further, in the pin terminal of the present invention, it is preferable that the biting portion is formed in a plurality of arrays in the pressing direction.

According to the preferred pin terminal, the pin terminal is more pressed and held in the terminal insertion hole with high strength due to the plurality of biting portions. further, according to the preferred pin terminal, since the plurality of biting portions are arranged in rows in the pressing direction, while a slope of the pin terminal can be prevented in the terminal insertion hole, the pin terminal can be pressed in the terminal insertion hole.

Further, in order to solve the above issue, the connector of the present invention has a connector housing in which a terminal insertion hole is provided, and a pin terminal pressed into the terminal insertion hole. The pin terminal is the above pin terminal of the present invention described above.

According to the connector of the present invention, since the pin terminal of the present invention described above is provided, leakage of the sealing member from the terminal insertion hole when the sealing member is filled in the connector housing can be suppressed.

Further, according to the present invention, leakage of the sealing member from the terminal insertion hole when the sealing member is filled in the connector housing can be suppressed.

### BRIEF DESCRIPTION OF THE DRAWINGS

FIG. 1 is an exterior perspective view showing a connector according to one embodiment of the preset invention;

FIG. 2 is a sectional view of the internal structure of the connector shown in FIG. 1 taken along a connecting direction with a mating connector;

FIG. 3 is a perspective view showing a pin terminal shown in FIGS. 1 and 2;

FIG. 4 is a sectional view of the connector taken along A-A in FIG. 2;

FIG. 5 is a sectional view of a first comparative example for the pin terminal and the connector shown in FIGS. 1-4 similar to FIG.4; and

FIG. 6 is a sectional view of a second comparative example for the pin terminal and the connector shown in FIGS. 1-4 similar to FIG.4.

### DESCRIPTION OF THE PREFERRED EMBODIMENT

Hereafter, one embodiment of a pin terminal and a connector in the present invention will be explained.

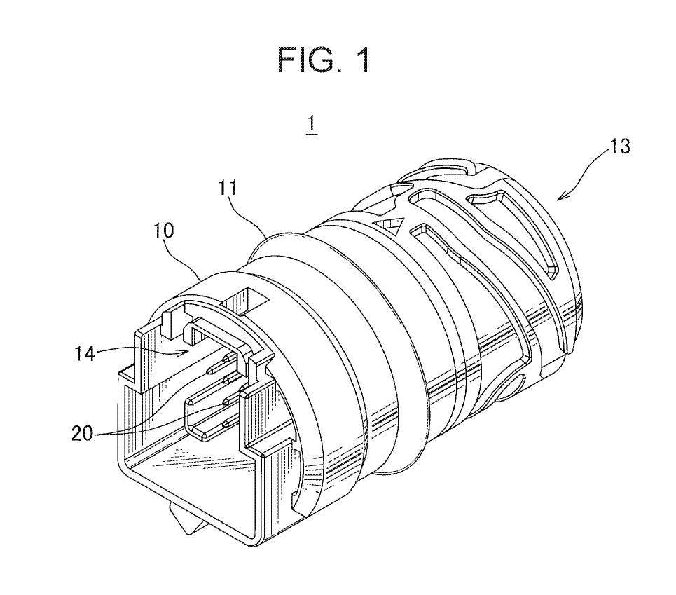

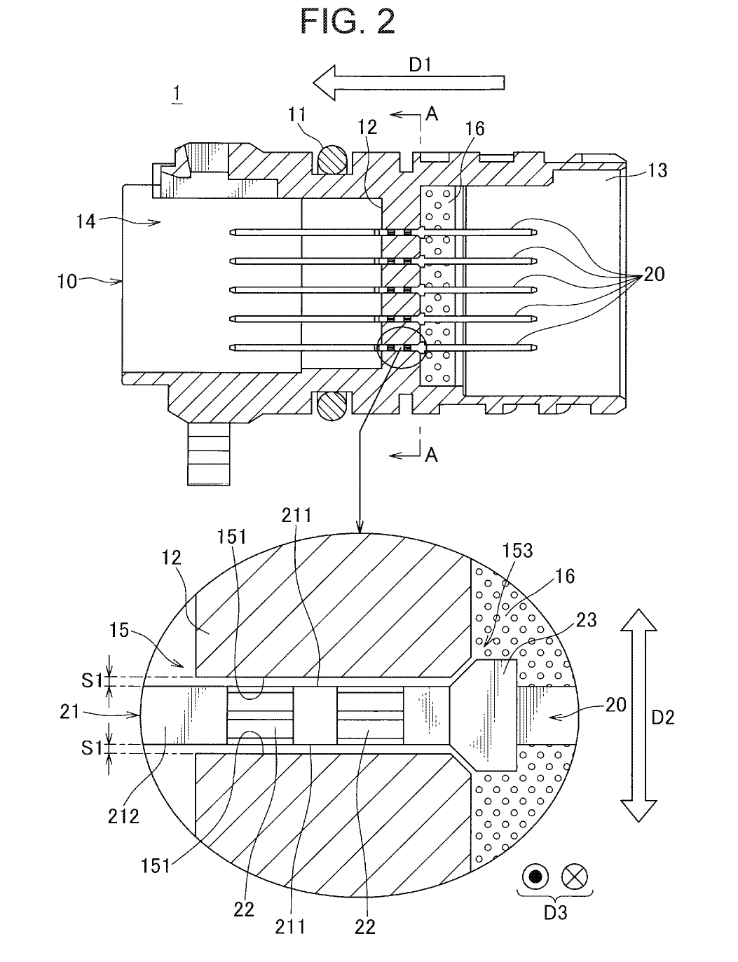

FIG. 1 is an exterior perspective view showing a connector according to one embodiment of the preset invention. FIG. 2 is a sectional view of the internal structure of the connector shown in FIG. 1 taken along a connecting direction with a mating connector.

A connector 1 shown in FIGS. 1 and 2 is a relay connector for electrical connection inside and outside a transmission. The connector 1 has a connector housing 10 in which a plurality of insertion holes 15 is arranged, and a plurality of pin terminals 20. Each of the plurality of pin terminals is pressed into each one of the plurality of insertion holes 15.

The connector housing 10 is made of resin and formed in a cylindrical shape. In outer surface thereof, an O-ring 11 for sealing is fitted midway in an axis direction. An inner side of the connector housing 10 is partitioned into a first fitting recess 13 and a second fitting recess 14 by a partition wall 12 in a middle portion of the axis direction. A mating connector not shown is inserted and fitted into each of the first fitting recess 13 and the second fitting recess 14. A plurality of terminal insertion holes 15 is provided in the partition wall 12 so as to pass through the partition wall 12 in the axis direction. A pin terminal 20 is pressed into each of the terminal insertion holes 15 one by one in a pressing direction D1 from the first fitting recess 13 toward the second fitting recess 14. Further, after pressing the pin terminal 20, the terminal insertion hole 15 is filled with a sealing member 16 so as to cover a surface of the partition wall 12 at a side of the first fitting recess 13, and is closed. Thereby, the connector 1 as a relay connector has high-sealing performance. As the sealing member 16, thermosetting resin is used. The sealing member 16 made of thermosetting resin is filled in an uncured state, and then cured.

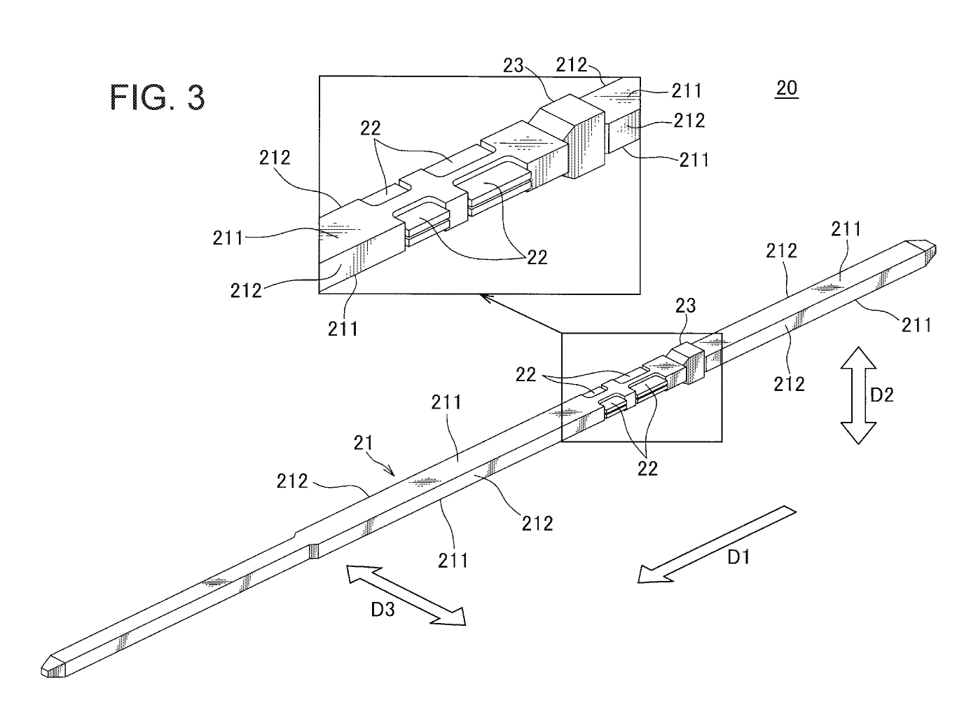

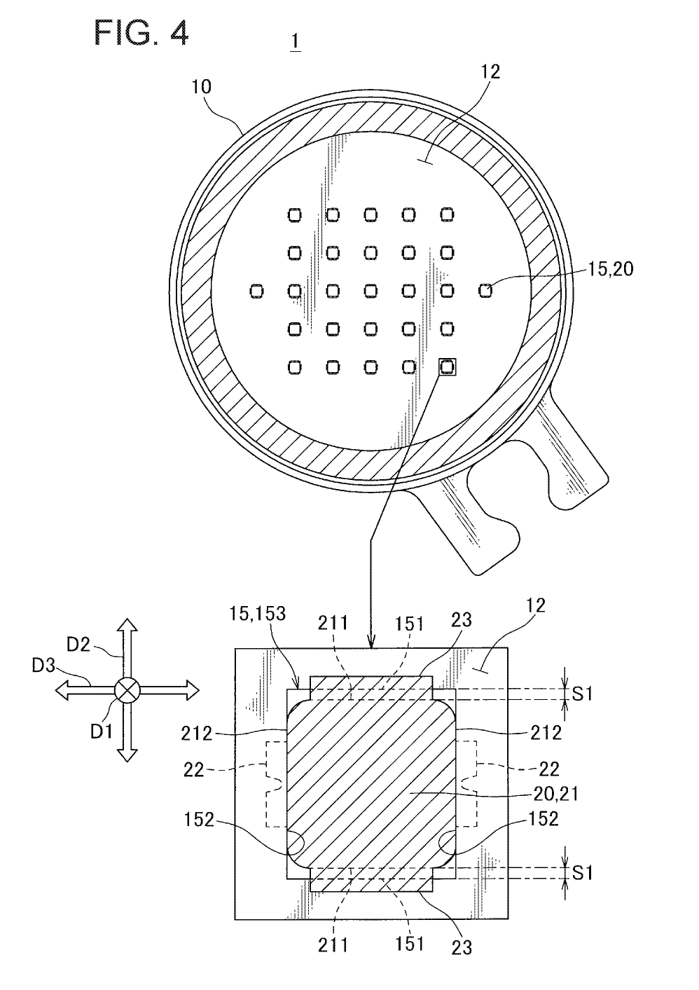

FIG.3 is a perspective view showing the pin terminal illustrated in FIGS. 1 and 2. FIG. 4 is a sectional view of the connector taken along A-A in FIG. 2.

The pin terminal 20 has a long terminal body 21, a biting portion 22 arranged in a middle section of the terminal body 21, and a blocking member 23 arranged behind the biting portion 22 in the pressing direction D1.

The terminal body 21 is formed by cutting a pre-plated metal wire rod and processing both ends thereof into a tapered shape. When the pin terminal 20 is pressed into the terminal insertion hole 15, as shown in the enlarged view of FIG. 2, the terminal body 21 penetrates through the terminal insertion hole 15 in a state that a space S1 is provided between inner wall surfaces of the terminal insertion hole 15 in a first direction D2 intersecting with the pressing direction D1. The space S1 performs a function as suppressing pressure resistance of the metal pin terminal 20 to the terminal insertion hole 15 in the resin connector housing 10 and reducing the generation of resin shavings caused when pressed into the terminal insertion hole.

Herein, as shown in the enlarged view of FIG. 4, the terminal insertion hole 15 is a square hole. On the other hand, the terminal body 21 has a square shape cut from a square wire rod as a metal wire rod. When the pin terminal 20 is pressed, the terminal body 21 passes through the terminal insertion hole 15 in a width direction perpendicular to a first pair of parallel surfaces 211 positioned in upper and down among four peripheral surfaces as the first direction D2. Then, in the first direction D2, the space S1 is provided between opposing surfaces 151 among the inner wall surfaces of the terminal insertion hole 15. The opposing surfaces 151 are faced to the first pair of parallel surfaces 211, respectively. On the other hand, a second pair of parallel surfaces 212 other than the first pair of parallel surfaces 211 touches with opposing surfaces 152 among the inner wall surfaces of the terminal insertion hole 15. The opposing surface 152 are faced to the second pair of parallel surfaces 212.

The biting portion 22 projects from a middle of the terminal body 21 in a second direction D3 intersecting with both the pressing direction D1 and the first direction D2. When the pin terminal 20 is pressed, the biting portion 22 bites into the inner wall surface of the terminal insertion hole 15. The biting portion 22 projects from each of the parallel surface 212 in a width direction as the second direction D3 perpendicular to the second pair of parallel surfaces 212 among four peripheral surfaces of the terminal body 21. When the pin terminal 20 is pressed, the biting portion 22 bites into the opposing surface 152 faced to each of the parallel surfaces 212 among the inner surfaces of the terminal insertion hole 15. According to the embodiment of the present invention, four biting portions 22 in total, in which two biting portions 22 are arranged on each of the second pair of parallel surfaces 212, are provided. Further, in each of the parallel surface 212, the biting portion 22 is formed in two rows in the pressing direction D1. Each of the biting portion 22 is formed by pressing process so that a part adjacent to each of the second pair of parallel surfaces 212 in the terminal body 21 is compressed in the first direction D2 and expanded in the second direction D3.

The blocking member 23 is a portion arranged behind the biting portion 22 of the terminal body 21 in the first direction D2 and formed with a width wider than the width of the terminal body 21. As shown in the enlarged views of FIG. 2 or 4, the blocking member 23 closes at least a part of the space S1 in a pressure inlet 153 of the terminal insertion hole 15 when the pin terminal 20 is pressed. Further, according to the embodiment of the present invention, as shown in the enlarged view of FIG. 2, the pressure inlet 153 of the terminal insertion hole 15 has a tapered shape in which the gap in the first direction D2 narrows toward the pressing direction D1. Furthermore, a front side of the blocking member 23 in the pressing direction D1 has a tapered shape fitted into the tapered shape of the pressure inlet 153. The blocking member 23 is arranged behind the biting portion in the pressing direction D1, and formed by pressing process so that a part of the terminal body 21 is compressed in the second direction D3 and expanded in the first direction D2.

The pressing processes of the biting portion 22 and the blocking member 23 are performed as part of outer formation as shown in the perspective view of FIG. 3 following a cutting process of the terminal body 22 from a metal wire rod.

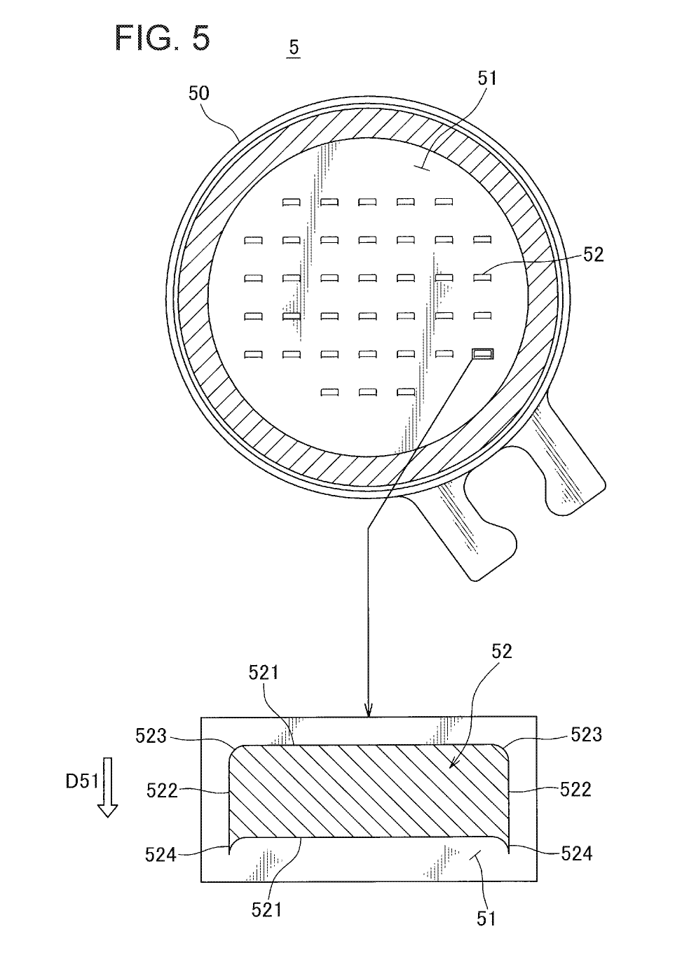

FIG. 5 is a view showing a first comparative example for the pin terminal and the connector shown in FIGS. 1 to 4, and is the sectional view similar to FIG. 4.

In a connecter 5 of the first comparative example, a pin terminal 52 is different from the pin terminal 20 shown in FIGS. 1 to 4. The pin terminal 52 punched from a pre-plated metal plate in a punching direction D51 with a bar shape is used. A plurality of the pin terminals 52 is integrally formed with a connector housing made of resin by insert molding. The plurality of the pin terminals 52 are integrated with a partition wall 51. Further, the sealing member not shown is filled so as to cover the partition wall 51, and thereby airtightness of a boundary surface between each of the pin terminal 52 and the partition wall 51 is ensured.

At this time, since the pin terminal 52 of the first comparative example is punched from the plated metal plate with a bar shape, a first pair of parallel surfaces 521 intersecting with the punching direction D51 are plated surfaces in which a plated process remains. On the other hand, a second pair of parallel surfaces 522 are non-plated surfaces in which the inner metal is exposed. Further, two corners of the pin terminal 52 at an upper side in the cross sectional drawing are sag surfaces 523, and two corners thereof at a lower side are burr surfaces 524.

For the first comparative example, according to the above embodiment, the pin terminal 20 is pressed into the terminal insertion hole 15 in the connector housing 10. For this reason, in comparison with the first comparative example adopting insert-molding causing increase in cost in facility, the pin terminal 20 can be attached to the connector at a relatively low cost.

Furthermore, in the first comparative example, the non-plated surface (the second pair of parallel surfaces 522) causing by punching process, the sag surface 523, and the burr surface 524 are formed in the pin terminal 52, and thereby adhesion property between each of these surfaces and the sealing member may become unstable in some cases. Thus, when high sealing performance is required, it is necessary to perform plate processing again to each of the pin terminal 52 prior to the above insert-molding. On the other hand, in the above embodiment of the present invention, the pin terminal 20 is formed on the base of the terminal body 21 which cut out from a pre-plated metal wire rod. So, the pin terminal 20 in which plate processing of the metal wire rod is maintained is formed, and the sag surface and the burr surface generated in the first comparative example are not formed. For this reason, high stability regarding adhesion property to the sealing member 16 is obtained. As a result, in the embodiment of the present invention, even if high sealing performance is required, it is not necessary to perform plate processing, and thereby manufacturing cost can be reduced compared with the first comparative example.

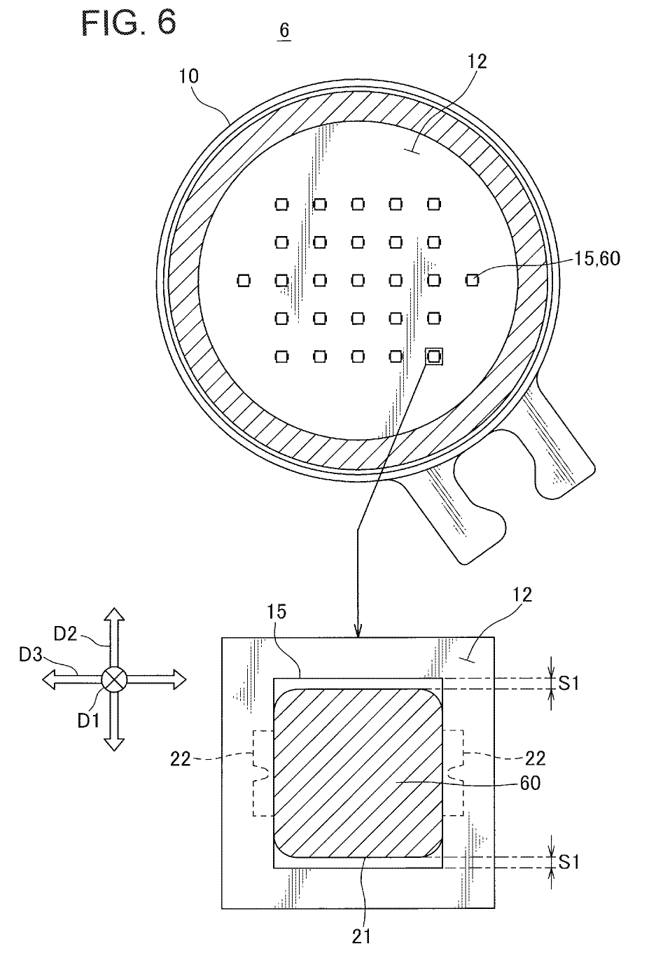

FIG. 6 is a view showing a second comparative example for the pin terminal and the connector shown in FIGS. 1 to 4, and is the sectional view similar to FIG. 4. Further, in this second comparative example, a connector 6 differs from the connector 1 of the above embodiment in that the pin terminal 60 does not have the blocking member 23 described above. In FIG. 6, the same numeral reference is assigned to the same components as the components shown in FIG. 4 in the embodiment of the present invention, and the description thereof is therefore omitted.

In the second comparative example, the pin terminal 60 is a press-fit terminal, and formed on the base of the terminal body 21 which is cut out from a pre-plated metal wire rod. Thus, manufacturing cost can be reduced compared with the first comparative example.

Herein, in the second comparative example, the space S1 is provided between the inner wall surface of the terminal insertion hole 15 in the partition wall 12 of the resin connector housing 10 and the terminal body 21. Thereby, pressure resistance of the metal pin terminal 20 to the terminal insertion hole 15 can be suppressed, and generation of resin shavings can be reduced. Meanwhile, in the second comparative example, when the sealing member is filled into the connector housing 10, the sealing member before curing may be leaked from the space S1. The leaked sealing member like this adheres to a connecting portion to a mating side terminal in the pin terminal 60, and thereby it is likely to cause degradation of electrical. Further, sealing performance may be decreased in the terminal insertion hole 15 due to leakage of the sealing member.

In the embodiment described above of the present invention, firstly the pin terminal 20 is pressed and held into the terminal insertion hole 15 satisfactory by biting into the inner wall surface of the terminal insertion hole 15 of the biting portion 22. At this time, owing to the space S1 between the inner wall surface of the terminal insertion hole 15 and the terminal body 21 in the first direction D2, generation of shavings when pressed into the terminal insertion hole can be prevented. Further, at least a part of the space S1 is blocked with the blocking member 23 in the pressure inlet 153 of the terminal insertion hole 15. Thereby, a leakage of the sealing member 16 from the terminal insertion hole 15 when the sealing member 16 is filled into the connector housing 10 can be prevented. As a result, electrical connection performance between the pin terminal 20 and the mating side terminal and sealing performance in the terminal insertion hole 15 can be improved as compared with the second comparative example.

Further, according to the embodiment of the present invention, since the pressure inlet 153 of the terminal insertion hole 15 is blocked by the blocking member 23 across the depth of the tapered shape, the leakage of the sealing member 16 can be further suppressed. Moreover, according to the embodiment of the present invention, since the blocking member 23 has the tapered shape fitted into the tapered shape of the pressure inlet 153 of the terminal insertion hole 15, when pressing the pin terminal 20 into the terminal insertion hole 15, a slope of the pin terminal 20 to the terminal insertion hole 15 can be prevented, and the positioning thereof can be performed with high accuracy.

Furthermore, according to the embodiment of the present invention, the shape of the terminal insertion hole 15 and the shape of the terminal body 21 corresponds to each other. In addition, the biting portion 22 bites into the opposing surfaces 152 faced to the second pair of the parallel surfaces 212 respectively. Therefore, the biting portion 22 bites into the opposing surface 152 approximately vertically, and holding strength of the pin terminal 20 can be increased when pressed. Further, since the blocking member 23 is formed wider in the first direction D2 along the opposing direction, the blocking member 23 blocks the space S1 between the flat surfaces faced to each other. Therefore, according to the embodiment of the present invention, for example in comparison with a case that a space between curved surfaces is blocked, the space S1 can be blocked over a wide range by the blocking member 23, and the leakage of the sealing member 16 can be further suppressed.

Further, according to the embodiment of the present invention, the biting portion 22 is formed in two rows in the pressing direction D2. Thereby, the pin terminal 20 is more pressed and satisfactorily held in the terminal insertion hole 15 with higher strength. Furthermore, according to the preferred pin terminal 20, since a plurality of biting portions 22 are arranged in the pressing direction D1, the slope of the pin terminal 20 to the terminal insertion hole 15 can be prevented, and thereby the pin terminal 20 can be pressed in the terminal insertion hole 15.

The above embodiments are shown as representative embodiments, and the present invention is not limited thereto. That is, those skilled in the art are capable of making various modifications according to conventional known knowledge without departing from the scope of the present invention. The modifications are included in the category of the present invention insofar as the configuration of the pin terminal and the connector according to the present invention is enabled in the modifications.

For example, according to the above embodiment, as one example of the connector in the present invention, the connector 1 as the relay connector to which the mating connecter is connected is illustrated. However, the connector of the present invention is not limited thereto. For example, it may be an end connector of a wire harness of which only one side is connected to the mating connector, and the other side is an electrical wire of a wire harness extends from the other side thereof. Alternatively, the connector of the present invention may be a connector for board of which one side is connected to the mating connector, and the other side is attached to a board. Further, according to the above embodiment, in the connector 1 as a relay connector, the embodiment in which the sealing member 16 is filled into the connector housing 10 is illustrated. However, when such the sealing performance is not needed in an end connector of a wiring harness or connector for plate board, the sealing member may not be filled.

For example, according to the above embodiment, as one example of the pin terminal in the present invention, the pin terminal 20 including the terminal body 21 having the prism shape cut from a square wire rod is illustrated. However, the pin terminal of the present invention is not limited thereto. For example, the pin terminal may include the terminal body having a round bar shape cut from a round wire rod. Herein, in the pin terminal 20 having the terminal body 21 of the square shape cut from the square wire rod, the blocking member 23 can block the space S1 between flat surfaces facing to each other across a wide range as compared with a case blocking a space between curved surfaces as described above.
1 connector
10 connector housing
11 O-ring
12 partition wall
13 first fitting recess
14 second fitting recess
15 terminal insertion hole
16 sealing member
20 pin terminal
21 terminal body
22 biting portion
23 blocking member
151, 152 opposing surface
153 pressure inlet
211, 212 parallel surface
D1 pressing direction
D2 first direction
D3 second direction
S1 space

1. A pin terminal pressed into a terminal insertion hole from a pressure inlet in a connector housing comprising:
a terminal body cut from a pre-plated metal wire rod, and passing through the terminal insertion hole in a state that a space is provided between inner wall surfaces of the terminal insertion hole in a first direction intersecting with a pressing direction when pressed into the terminal insertion hole;
a biting portion projecting from a middle of the terminal body in a second direction intersecting with both the pressing direction and the first direction, and biting into the inner wall surface when pressed into the terminal insertion hole; and
a blocking member formed behind the biting portion in the terminal body in the pressing direction with a width wider than a width of the terminal body in the first direction, and blocking at least a part of the space in the pressure inlet when pressed into the terminal insertion hole.

2. The pin terminal according to claim 1, wherein the pressure inlet has a tapered shape in which an gap in the first direction narrows in the pressing direction, and a front side of the blocking member in the pressing direction has a tapered shape fitted into the tapered shape of the pressure inlet.

3. The pin terminal according to claim 1, wherein the terminal insertion hole is a square hole,
the terminal body has a square shape cut from a square wire rod as the metal wire rod, and passes through the terminal insertion hole in a state that the space is provided between first opposing surfaces among the inner wall surfaces in the first direction as a width direction perpendicular to a first pair of parallel surfaces among four peripheral surfaces of the terminal body, and the first opposing surfaces being faced to the first pair of parallel surfaces respectively,
the biting portion projects in the second direction as a width direction perpendicular to a second pair of parallel surfaces other than the first pair of parallel surfaces among the four peripheral surfaces, and bites into second opposing surfaces among the inner wall surfaces, the second opposing surfaces being faced to the second pair of parallel surfaces respectively, and
the blocking member is formed wider in the first direction.

4. The pin terminal according to claim 1, wherein the biting portion is arranged plurally in the pressing direction.

5. A connector comprising:
a connector housing in which a terminal insertion hole is provided; and
a pin terminal pressed into the terminal insertion hole,
wherein the pin terminal is the pin terminal described in claim 1.

6. The pin terminal according to claim 2, wherein the terminal insertion hole is a square hole,
the terminal body has a square shape cut from a square wire rod as the metal wire rod, and passes through the terminal insertion hole in a state that the space is provided between first opposing surfaces among the inner wall surfaces in the first direction as a width direction perpendicular to a first pair of parallel surfaces among four peripheral surfaces of the terminal body, and the first opposing surfaces being faced to the first pair of parallel surfaces respectively,
the biting portion projects in the second direction as a width direction perpendicular to a second pair of parallel surfaces other than the first pair of parallel surfaces among the four peripheral surfaces, and bites into second opposing surfaces among the inner wall surfaces, the second opposing surfaces being faced to the second pair of parallel surfaces respectively, and
the blocking member is formed wider in the first direction.

7. The pin terminal according to claim 2, wherein the biting portion is arranged plurally in the pressing direction.

8. The pin terminal according to claim 3, wherein the biting portion is arranged plurally in the pressing direction.

9. The pin terminal according to claim 6, wherein the biting portion is arranged plurally in the pressing direction.
